(19) United States
(12) Patent Application Publication
(10) Pub. No.: US 2020/0391109 A1
(43) Pub. Date: Dec. 17, 2020

(54) METHOD AND SYSTEM FOR MANAGING EMOTIONAL RELEVANCE OF OBJECTS WITHIN A STORY

(71) Applicant: Unity IPR ApS, Copenhagen (DK)

(72) Inventors: Adam Myhill, Mayne Island (CA); Gregory Labute, Outremont (CA)

(21) Appl. No.: 16/900,603

(22) Filed: Jun. 12, 2020

Related U.S. Application Data
(60) Provisional application No. 62/860,741, filed on Jun. 12, 2019.

(51) Int. Cl. A63F 13/5258; G06K 9/00; G06F 16/41; A63F 13/5252

(52) U.S. Cl. CPC A63F 13/5258; G06K 9/00765; G06F 16/41; A63F 2300/6684; G06K 2009/00738; A63F 2300/6669; A63F 13/5252

(57) ABSTRACT

A method for determining cinematic shot quality of objects of interest within a frame of a video associated with a video game is disclosed. A plurality of objects of interest are determined from a set of objects from within the video game. Game state data is received from the game. The game state data describes at least a set of events occurring within the game. A plurality of interest level values is determined. A plurality of starvation values is determined for the plurality of objects of interest. A plurality of urgency values is determined for the plurality of objects of interest. A data structure is generated for use in managing cinematography associated with the frame. The data structure facilitates looking up of the plurality of interest level values and urgency values.

### CROSS-REFERENCE TO RELATED APPLICATIONS

This application claims the benefit of U.S. Provisional Application No. 62/860,741, filed Jun. 12, 2019, which is incorporated by reference herein in its entirety.

### TECHNICAL FIELD

The subject matter disclosed herein generally relates to the technical field of computer systems and, more specifically, to computer systems and methods for managing the importance and emotional relevance of virtual objects for automated cinematography.

### BACKGROUND OF THE INVENTION

Multiplayer video game environments are difficult to film in a pleasing way. This is due to game elements changing quickly along with the unpredictability of player movement and game action. In non-video game environments cameras are typically positioned with a priori knowledge of interesting subjects and events (or at least a high probability of predictability of subjects and events). This is particularly true for sporting events where a plurality of cameras are typically placed in predefined locations (or predefined tracks) with predefined views in order to catch significant events in a game whose locations are somewhat predictable. Cameras are often placed near a goal or net thus capturing the important events surrounding changes in score. Even if the action is not known in advance, the physical size limitation of a field (or court) limits the number of cameras needed to capture all the action of a game. However, video games usually involve vast environments where the user is in complete control and has an almost infinite set of possible paths and actions. The ability to film an unpredictable actor in an unknown situation with quality is difficult. Also, many interesting events are often happening simultaneously, which makes it difficult to determine which of the events should be filmed, and in what way it should be filmed, and for how long. Furthermore, an important aspect missing within the field of automated cinematography is a mechanism for managing the importance and emotional relevance of game objects.

### BRIEF DESCRIPTION OF THE DRAWINGS

Further features and advantages of example embodiments of the present invention will become apparent from the following detailed description, taken in combination with the appended drawings, in which:

FIG. 1A is a schematic illustrating a story manager device, in accordance with one embodiment;

FIG. 1B is a schematic illustrating a story manager method using a story manager device, in accordance with one embodiment;

FIG. 2 is a schematic illustrating a method for story management using a story manager device, in accordance with one embodiment;

FIG. 3 is a schematic illustrating a cinematography method using a story manager device, in accordance with one embodiment;

FIG. 4 is a schematic illustrating a director method using a story manager device, in accordance with one embodiment;

FIG. 5 is a block diagram illustrating an example software architecture, which may be used in conjunction with various hardware architectures described herein; and

FIG. 6 is a block diagram illustrating components of a machine, according to some example embodiments, configured to read instructions from a machine-readable medium (e.g., a machine-readable storage medium) and perform any one or more of the methodologies discussed herein.

It will be noted that throughout the appended drawings, like features are identified by like reference numerals.

### DETAILED DESCRIPTION

The description that follows describes example systems, methods, techniques, instruction sequences, and computing machine program products that comprise illustrative embodiments of the disclosure, individually or in combination. In the following description, for the purposes of explanation, numerous specific details are set forth in order to provide an understanding of various embodiments of the inventive subject matter. It will be evident, however, to those skilled in the art, that various embodiments of the inventive subject matter may be practiced without these specific details.

The term ‘environment’ used throughout the description herein is understood to include 2D digital environments (e.g., 2D video game environments, 2D simulation environments, 2D content creation environments, and the like), 3D digital environments (e.g., 3D game environments, 3D simulation environments, 3D content creation environments, virtual reality environments, and the like), and augmented reality environments that include both a digital (e.g., virtual) component and a real-world component.

The term ‘game object’, used throughout the description herein is understood to include any digital object or digital element within an environment. A game object can represent (e.g., in a corresponding data structure) almost anything within the environment; including 3D models (e.g., characters, weapons, scene elements (e.g., buildings, trees, cars, treasures, and the like)) with 3D model textures, backgrounds (e.g., terrain, sky, and the like), lights, cameras, effects (e.g., sound and visual), animation, and more. The term ‘game object’ may also be understood to include linked groups of individual game objects. A game object is associated with data that defines properties and behavior for the object.

The terms ‘asset’, ‘game asset’, and ‘digital asset’, used herein are understood to include any data that can be used to describe a game object or can be used to describe an aspect of a project (e.g., including: a game, a film, a software application). For example, an asset can include data for an image, a 3D model (textures, rigging, and the like), a group of 3D models (e.g., an entire scene), an audio sound, a video, animation, a 3D mesh and the like. The data describing an asset may be stored within a file, or may be contained within a collection of files, or may be compressed and stored in one file (e.g., a compressed file), or may be stored within a memory. The data describing an asset can be used to instantiate one or more game objects within a game at runtime.

The term ‘runtime’ used throughout the description herein should be understood to include a time during which a program (e.g., an application, a video game, a simulation, and the like) is running, or executing (e.g., executing programming code). The term should be understood to include a time during which a video game is being played by a human user or played by an artificial intelligence agent.

The terms ‘client’ and ‘application client’ used herein are understood to include a software client or software application that accesses data and services on a server, including accessing over a network.

Operations for determining cinematic shot quality of objects of interest within a frame of a video associated with a video game is disclosed. A plurality of objects of interest are determined from a set of objects from within the video game. Game state data is received from the game, the game state data describing at least a set of events occurring within the game. A plurality of interest level values is determined. The plurality of interest level values corresponds to a plurality of categories associated with the plurality of the objects of interest and the plurality of interest level values is based on the game state data. A plurality of starvation values is determined for the plurality of objects of interest. Each of the plurality of the starvation values is inversely related to a running total of an amount of time an object of interest of the plurality of objects of interest is visible in previous frames. A plurality of urgency values is determined for the plurality of objects of interest. Each of the plurality of urgency values is based on the plurality of interest level values and the starvation value associated with an object of interest and the urgency values represent a measure of urgency to see the object of interest in the frame. A data structure is generated for use in managing cinematography associated with the frame. The data structure facilitates the looking up of the plurality of interest level values and urgency values.

The present invention includes apparatuses which perform one or more operations or one or more combinations of operations described herein, including data processing systems which perform these methods and computer readable media which when executed on data processing systems cause the systems to perform these methods, the operations or combinations of operations including non-routine and unconventional operations.

Turning now to the drawings, systems and methods, including non-routine or unconventional components or operations, or combinations of such components or operations, for managing the emotional relevance of objects within a story in accordance with embodiments of the invention are illustrated. In many embodiments, there is provided a story manager system for managing the emotional relevance of objects within a story.

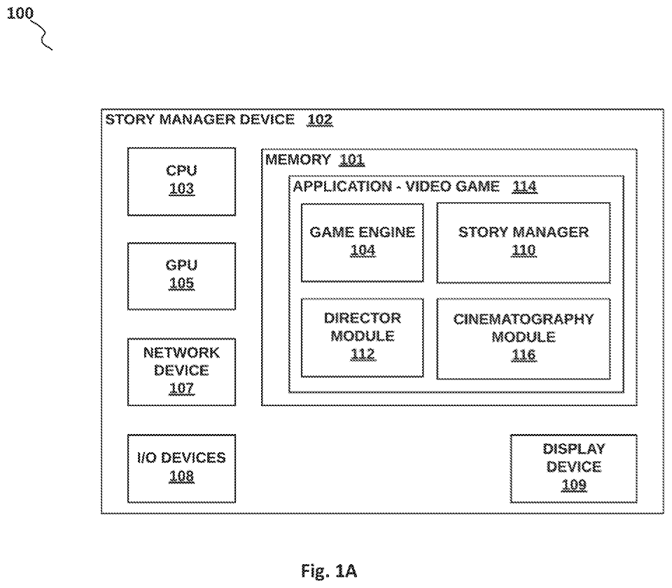

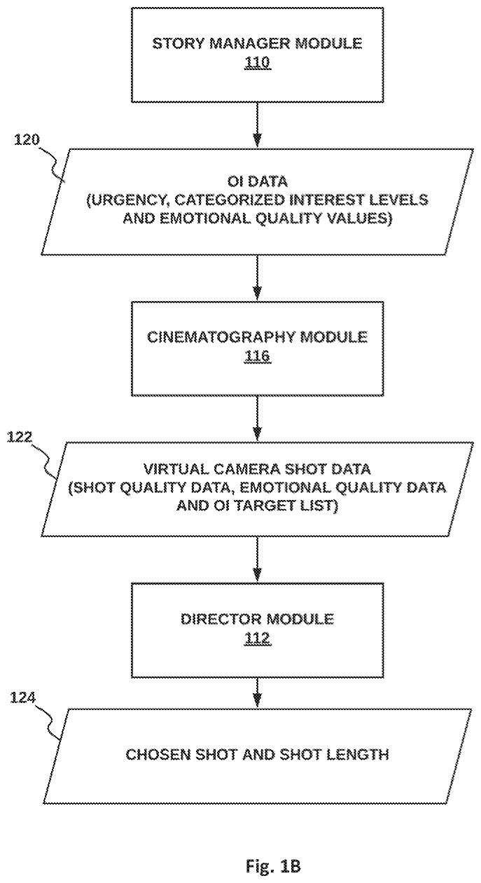

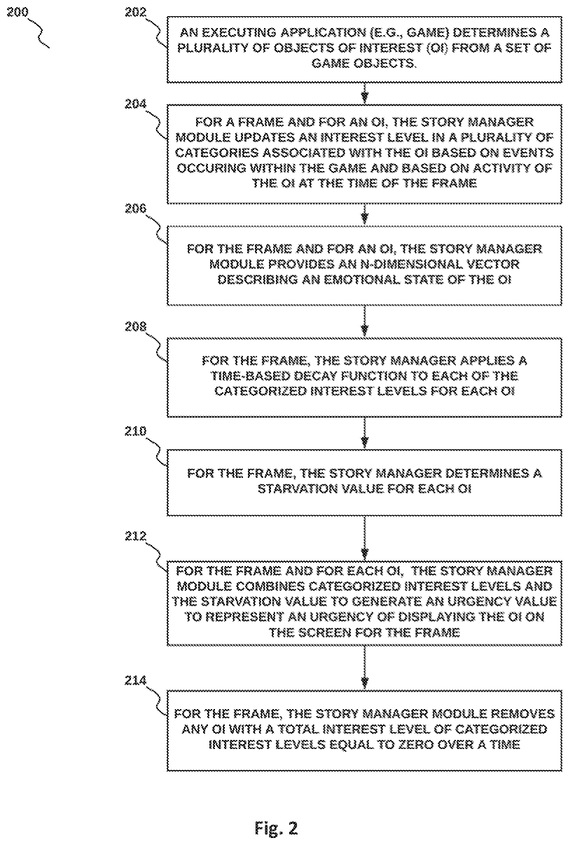

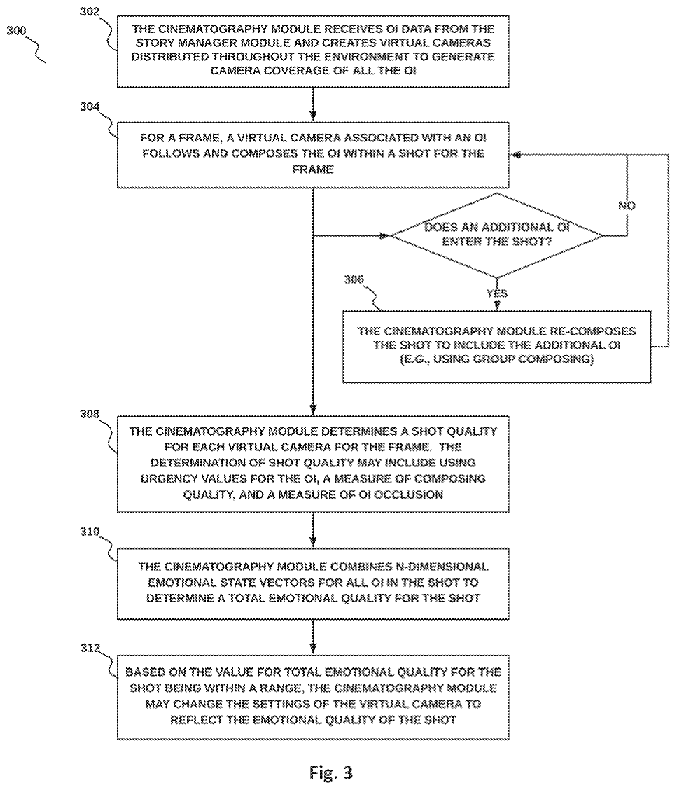

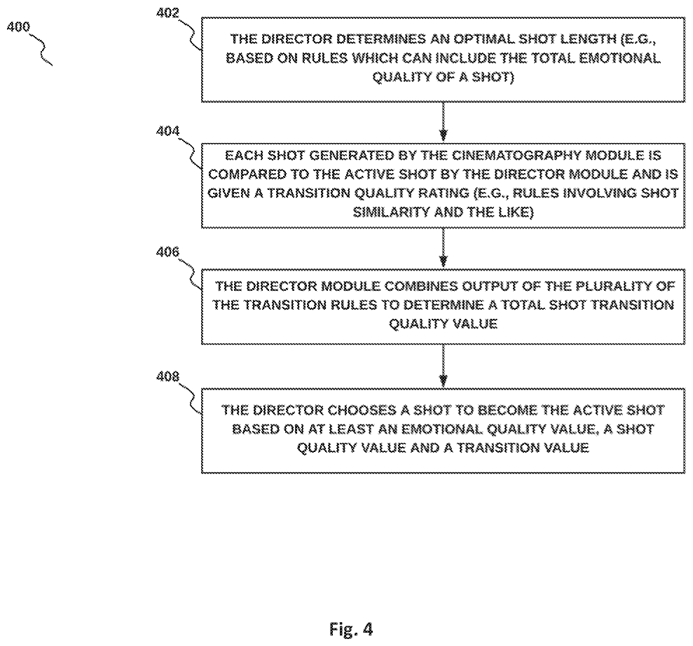

In accordance with an embodiment, and shown in FIG. 1A is a story manager system 100. The story manager system 100 including a story manager device 102, the story manager device 102 including one or more central processing units 103 (CPUs), and graphics processing units 105 (GPUs). The CPU 103 is any type of processor, processor assembly comprising multiple processing elements (not shown), having access to a memory 101 to retrieve instructions stored thereon, and execute such instructions. Upon execution of such instructions, the instructions implement the story manager device 102 to perform a series of tasks as described herein (e.g., in reference to FIG. 1B, FIG. 2, FIG. 3, and FIG. 4). The memory 101 can be any type of memory device, such as random access memory, read only or rewritable memory, internal processor caches, and the like.

The story manager device 102 also includes one or more input/output devices 108 such as, for example, a keyboard or keypad, mouse, pointing device, camera, a microphone, a hand-held device (e.g., hand motion tracking device), a touchscreen and the like, for inputting information in the form of a data signal readable by the processing device. The story manager device 102 further includes one or more display devices 109, such as a computer monitor, a touchscreen (e.g., of a tablet or smartphone), and lenses or visor of a head mounted display (e.g., virtual reality (VR) or augmented reality (AR) HMD), which may be configured to display digital content including video, a video game environment, an integrated development environment and a virtual simulation environment and may also be configured to display virtual objects in conjunction with a real-world view. The display device 109 is driven or controlled by the one or more GPUs 105 and optionally the CPU 103. The GPU 105 processes aspects of graphical output that assists in speeding up rendering of output through the display device 109. The story manager device 102 also includes one or more networking devices 107 (e.g., wired or wireless network adapters) for communicating across a network.

The memory 101 in the story manager device 102 can be configured to store an application 114 (e.g., a video game, a simulation, or other software application) which can include a game engine 104 (e.g., executed by the CPU 103 or GPU 105) that communicates with the display device 109 and also with other hardware such as the input device(s) 108 to present the application to the user 130 (e.g., presenting of a video game). The game engine 104 would typically include one or more modules that provide the following: animation physics for game objects, collision detection for game objects, rendering, networking, sound, animation, and the like in order to provide the user with an application environment (e.g., video game or simulation environment). The application 114 includes a story manager 110 that provides various story manager system functionality as described herein. The application 114 may include a director module 112 that provides various cinematographic director system functionality as described herein. The application 114 may include a cinematography module 116 that provides various cinematography system functionality as described herein. Each of the game engine 104, the story manager 110, the director module 112, the cinematography module 116, and the application 114 includes computer-executable instructions residing in the memory 101 that are executed by the CPU 103 and optionally with the GPU 105 during operation (e.g., while performing operations described with respect to FIG. 1B, FIG. 2, FIG. 3, and FIG. 4). The game engine 104 includes computer-executable instructions residing in the memory 101 that are executed by the CPU 103 and optionally with the GPU 105 during operation in order to create a runtime program such as a game engine. The application 114 includes computer-executable instructions residing in the memory 101 that are executed by the CPU 103 and optionally with the GPU 105 during operation in order to create a runtime application program such as a video game. The game engine 104, the story manager 110, the director module 112, and the cinematography module 116 may be integrated directly within the application 114, or may be implemented as external pieces of software (e.g., plugins).

In accordance with an embodiment and shown in FIG. 1B is an example flow of data between the story manager module 110, the cinematography module 116 and the director module 112. While shown as three separate modules for convenience of explanation, it will be understood by those skilled in the art, that the three separate modules (e.g., 110, 112, and 116) may be implemented within one single module. In accordance with an embodiment, the story manager module 110, the cinematography module 116 and the director module 112 are modules that exist during the execution of the application such as in a runtime version of the application 114 (e.g., during game play of a video game). In accordance with an embodiment, and as further described below in a method 200 described in reference to FIG. 2, the story manager module 110 determines a plurality of objects of interest (OI) within an environment (e.g., a game level) related to the application 114, and for each OI determines OI data 120 that includes the following: an emotional quality value, a plurality of categorized interest levels, and an urgency value. In accordance with an embodiment, and as further described below in a method 300 described in reference to FIG. 3, the cinematography module 116 distributes virtual cameras in the environment to follow the determined OI and compose a camera shot (e.g., for a frame) of the determined objects of interest. The distribution of the virtual cameras being at least in part based on the emotional quality value, categorized interest levels, and urgency values determined by the story manager module 110. The distributed virtual cameras record composed camera shots over time. The cinematography module 116 may also determine a shot quality for each shot of each virtual camera based at least in part on the emotional quality value, categorized interest levels, and urgency values determined by the story manager module 110. The cinematography module 116 outputs virtual camera shot data 122 that includes a list of a plurality of potential virtual camera shots, with each shot having associated data that includes a shot quality value, a total emotional quality value, and a list of objects of interest visible within the shot. In accordance with an embodiment, and as further described with respect to a method 400 described with reference to FIG. 4, the director module 112 determines an optimal shot length and a measure of transition quality between shots. The director module 112 may then choose a final shot from the plurality of potential shots based on shot quality, transition quality and emotional quality.

In accordance with an embodiment and shown in FIG. 2 is a method 200 for determining objects of interest (OI) within an executing application 114 (e.g., a runtime version of the application 114) as well as determining an interest quality and an emotional quality for the objects of interest. In accordance with an embodiment, the application 114 may be executing on the story manager device 102 and may be providing a video game experience to a user. The executing application 114 may generate data for frames to be rendered and displayed on the display device 109 on a continuous basis (e.g., 60 frames per second, 90 frames per second, or any other frame rate). The executing application 114 may generate and destroy game objects within an environment, wherein the game objects can change from frame to frame (e.g., moving, changing appearance, disappearing, and the like). The executing application 114 may also generate events (e.g., actions which occur) within the environment and which can involve game objects.

In accordance with an embodiment, at operation 202 of the method 200, the executing application 114 determines a plurality of objects of interest (OI) from the set of existing game objects within the environment. A determined OI is a game object that includes a value for position within the environment (e.g., 3D coordinates), has a size greater than zero, and can potentially be seen by a virtual camera placed within the environment. The plurality of determined OI can change from frame to frame as the application 114 changes game objects within the environment (e.g., during game play). In accordance with an embodiment, an OI that exists at a time associated with a frame is referred to herein as an active OI. In accordance with an embodiment, an active OI is considered a potential camera target for the story manager system 100. In accordance with an embodiment, operation 202 occurs at a low frequency (e.g., not for every frame), which may improve performance of the story manager system 100 by reducing a computational processing involved in determining OI. In accordance with an embodiment, operations 204 through to 214 are performed at least once for each frame generated by the application 114 during a runtime. In accordance with an embodiment, there is provided by the executing application 114 a list of categories of interest for an OI, wherein each category can include one or more of the following: a value describing an interest level for the category, a rate function describing the rate of decay of the interest level value for the category, and a maximum for the interest level describing the maximum value of the category for an event. There can be multiple categories of interest for an OI with each category having a different rate of decay and a different maximum for each category and for each OI. The interest level of a category is a value that describes an interest for the associated OI with respect to the category. In accordance with an embodiment, the interest level value and the rate of decay function for the interest level may be pre-determined and included with the application 114 (e.g., by an application developer). The category may be related to an aspect of a story within the application 114 (e.g., story for a video game) and to an aspect of cinematography. The categories of interest and the values therein associated with an OI describe an interest for the OI with respect to a story within the executing application 114 on a frame by frame basis (e.g., over time such as during a game play session). A category associated with an OI can be associated with an event within a game wherein the event can include any of the following: an action within the executing application 114 which directly affects the OI, an action within the application which occurs in a proximity to the OI, and activity of the OI whereby the activity is associated with the category. In accordance with an embodiment, a high value of rate of decay for an interest level value can be used to describe an event where the interest level value for the event decreases quickly (e.g., from one frame to the next). Similarly, a low value of rate of decay for an interest level value can be used to describe an event where the interest level value for the event decreases slowly. For example, a gunshot event within the executing application 114 may have a large interest level value with a large value for the rate of decay so that the gunshot event could have a high initial interest value that decays quickly. As another example, a teleportation event for an OI may have a large interest level value but with a low value for the rate of decay so that the interest level associated with the teleportation event may last longer than the interest level associated with the gunshot event. As an example of the maximum value of interest in a category, an event involving three rapid gunshots can have a higher interest value than an event involving a single gunshot, however, the interest value for the event with the three rapid gunshots can not exceed the maximum value associated with the event. In accordance with an embodiment, the story manager module 110 is agnostic about the precise nature of game events.

In accordance with an embodiment, as part of operation 204 of the method 200, the executing application 114 may update each category level value of the categorized interest levels for each OI based on the game events and OI activity. The updating may occur once per frame (e.g., on a frame by frame basis) or less frequently. As part of operation 204, for each frame, the story manager module 110 calculates a value for total interest for an OI, wherein the total interest value is the sum of interest values in all categories associated with the OI.

In accordance with an embodiment, based on the application 114 being a game and having a plurality of gameplay states (e.g., a ‘sneaking’ state, a ‘discovered’ state, a ‘full battle’ state and the like) wherein the behavior of the game is different for each state, there is provided an OI priority map for each state. The OI priority map for a state includes a plurality of interest values that are specific to the state (e.g., including an interest value for each category of each OI and associated events). There is no limit to the number of gameplay states and associated OI priority maps. For example, an OI priority map for a ‘sneaking’ state of a game can have different interest values than an OI priority map for a ‘discovered’ state. A single dropped gun shell in ‘sneaking’ state is of high interest because the event is loud and can lead to the gameplay state switching to ‘discovered’; however, the single shell drop event is very low priority in a ‘full battle’ state wherein things are more intense. In accordance with an embodiment, each OI has an interest value, a decay rate and a max, for each OI priority map and for each category.

In accordance with an embodiment, at operation 206 of the method 200, the story manager module 110 provides an n-dimensional emotion vector to describe an emotional quality of an OI, wherein ‘n’ is any positive integer (e.g., 3-dimensional emotion vector, 4-dimensional emotion vector, and the like). Each dimension within the emotion vector may describe an aspect of emotion for the OI. In accordance with an embodiment, the emotion vector may be used to change a shot composition (e.g., in operation 312) and a shot length (e.g., in operation 402) to convey an emotion to an external viewer of the display device 109 (e.g., a player of the game). The aspects of emotion may include happiness, fear, surprise, sadness, anger, disgust, and the like. In accordance with an embodiment, a single value for emotion may be calculated using the individual values within the emotion vector (e.g., sum of n individual values, or sum of squared n individual values, or any other type of sum of the n individual values). In accordance with an embodiment, the emotion vector values may be zero to represent the absence of information on emotion. The story manager module 110 may change the individual values of an emotion vector at each frame in order to indicate an emotional state associated with the OI and based on game events and actions of a plurality of active OIs. For example, an emotional vector associated with one OI may be modified by other OI within the same frame. WE MAY NEED TO EXPAND ON THIS DEFINITION For example, an OI (e.g., a specific character within a game) may have an emotion value of 3 for a frame, however at a later frame a second OI appears (e.g., a monster) with a total emotion value of 6 such that the total emotion value for the frame increases from 3 to 9.

In accordance with an embodiment, at operation 208 of the method 200, the story manager module 110 applies the time-based decay functions (e.g., as described with respect to operation 204 of the method 200) to each of the categorized interest levels for each OI. In accordance with an embodiment, operation 208 may be performed once per frame or may be performed less often (e.g., once every two or three frames). The decay functions may serve to lower the interest level values for an OI over time (e.g., over a plurality of frames) in order to make the OI seem less interesting or important to the story manager system 100.

In accordance with an embodiment, at operation 210 of the method 200, the story manager module 110 determines a starvation value for each OI. The starvation value is a scalar quantity associated with an OI that increases over time (e.g., over a plurality of frames) based on the OI not being visible on-screen (e.g., in a camera view being displayed on the display device 109), and decreases over time based on the OI being visible on-screen. The starvation value is a measure of desire to bring an OI onto a visible screen wherein the desire increases with an amount of time the OI is away from the visible screen and decreases while the OI is on screen. The starvation value may help to make some OIs visible on the screen. In accordance with an embodiment, operation 210 may be performed once per frame or may be performed less often (e.g., once every two or three frames).

In accordance with an embodiment, at operation 212 of the method 200, for each OI, the story manager module 110 combines the categorized interest levels and the starvation value to create a value referred to herein as an urgency value. The combination may be done using any mathematical method (e.g., linear combination, averaging, and more). The urgency value for an OI represents a measure of urgency (e.g., from a story perspective) to have the OI displayed on-screen at a moment (e.g., in a camera view being displayed on the display device). In accordance with an embodiment, operation 212 may be performed once per frame or may be performed less often (e.g., once every two or three frames). In accordance with an embodiment, the urgency value of an OI may be a weighted version of the starvation value of the OI wherein the weight is determined by the categorized interest levels. An OI with a starvation value and large values of interest levels may have a larger urgency than a second OI with the same starvation value but with smaller values of interest levels. The urgency value increases a desire for more interesting OIs to be made visible on a display screen.

In accordance with an embodiment, at operation 214 of the method 200, the story manager module 110 checks the total interest value for all categorized interest level values for all active OIs. Based on a total interest value for an OI being equal to zero, the story manager module 110 determines an amount of time over which the total interest value remained zero. Based on the total interest value for an OI being equal to zero for a threshold time, the story manager module 110 removes the OI from the set of OIs (e.g., so that the OI is no longer considered a potential camera target). The threshold time may be predetermined (e.g., by a developer of a game). In accordance with an embodiment, operation 214 is optional and may not be performed.

In accordance with an embodiment, for each frame, the story manager module 110 provides an output that includes data for each OI. The data including an urgency value, categorized interest level values and emotional quality values for an OI. In accordance with an embodiment, the story events, categorized interest levels, and decay functions are parameters that can be tuned (e.g., by a game developer) to modify the behavior of the system 100 for an application or game.

In accordance with an embodiment, and shown in FIG. 3 is a method 300 which may be performed by the cinematography module 116. In the method 300, at operation 302, the cinematography module 116 receives the output data from the story manager module 110 (e.g., data output from operation 202 through to operation 214). The output data including data on active OIs. As part of operation 302, the cinematography 116 module may use existing virtual cameras or create new virtual cameras within the environment to ensure that all active OIs are covered by at least one virtual camera (e.g., whereby an OI is in the view of the one virtual camera). Based on an OI having no virtual cameras covering it, the cinematography module 116 may create a new virtual camera whereby the new virtual camera is positioned to cover the OI (e.g., have the OI in a view of the virtual camera). In accordance with an embodiment, operation 302 may occur every frame, or may occur over longer periods of time (e.g., after many frames). In accordance with one embodiment, during operation 302, a new virtual camera may be created based on a generation of a new OI (e.g., generated by the application 114 due to events and to game play). In accordance with an embodiment, settings for the virtual cameras used in operation 302 may be based on templates and rules and may be predetermined in the application 114 (e.g., programmed into the application 114 via programming instructions). The settings for the virtual cameras may include values describing lense properties for the camera, and subject framing algorithms, and subject following algorithms, and the like. The subject framing algorithms and the subject following algorithms may be dynamic algorithms that cause a camera to follow an OI and which take as input at least one or more of the following data associated with the OI: a position, a size, an orientation and an emotional vector.

In accordance with an embodiment, in operation 304 of the method 300, each virtual camera that is associated with an OI uses the camera settings to follow and compose the OI within a shot for the frame (e.g., as the OI moves throughout the environment of the game from frame to frame). The composing including arranging elements (e.g., including OIs and other game objects) within a camera shot of a virtual camera based on the rules or the templates. In accordance with an embodiment, as part of operation 304, based on the virtual camera being mobile, the virtual camera will follow the OI by doing one or more of the following: moving position for the frame (e.g., in 3D coordinates within the environment), rotating in 3 orthogonal axes for the frame and modifying camera properties for the frame. The following including maintaining a composition of the OI within the frame. In accordance with an embodiment, as part of operation 304, based on the virtual camera being stationary, the stationary camera uses rotation and modification of camera properties to maintain the composition of the OI in the frame until the OI goes out of view (e.g., moves behind an object) and is no longer a possibility for composition.

In accordance with an embodiment, at operation 306 of the method 300, based on one or more additional OI entering a shot from a virtual camera for the frame (e.g., based on an additional OI coming near to a targeted OI for the virtual camera), the cinematography module 116 may re-compose the shot from the virtual camera to include the one or more additional OI in the frame (e.g., composing the group of OI using a group composition algorithm).

In accordance with an embodiment, at operation 308 of the method 300, the cinematography module 116 determines a shot quality for each virtual camera for the frame. The shot quality may be a scalar quantity and may be determined based on rules. The shot quality may be a function of one or more of the following: urgency values for one or more OI visible within the shot; size and position of the one or more OI visible within the shot; and a measure for occlusion within a camera frustum. In accordance with an embodiment, the shot quality is positively related to the value of the urgency values for OI within the shot such that high urgency values are associated with high shot quality values. For example, an OI that has a high urgency value and is large in the frame may have a higher shot quality than a second OI that has a lower urgency value or is poorly composed (e.g., off to one side). In accordance with an embodiment, based on there being occlusion of an OI within a shot, the shot quality value for that shot is lowered. In accordance with an embodiment, operation 308 may be performed once per frame or may be performed less often (e.g., once every two or three frames).

In accordance with an embodiment, at operation 310 of the method 300, the cinematography module 116 combines the n-dimensional emotional state vectors for all OI within a shot to determine a total emotional quality value for the shot. In accordance with an embodiment, the combining of the n-dimensional emotional state vectors may include a vector summation, a squared sum, a weighted sum, an averaging, or the like. In accordance with an embodiment, operation 310 may be performed once per frame or may be performed less often (e.g., once every two or three frames).

At operation 312 of the method 300, based on the value for total emotional quality for a shot from a virtual camera being within a range of a predetermined set of ranges, the cinematography module 116 may change settings of the virtual camera to reflect the emotional quality of the shot for the range. The change of settings may be done in accordance with cinematographic rules for the range; for example dutch camera rotation (e.g., camera rotation around the z-axis of the camera) or low camera angles may be introduced during highly emotionally charged moments (e.g., frames with a large total emotional quality value which falls within a range or which is greater than a threshold). In accordance with an embodiment, operation 312 may be performed once per frame or may be performed less often (e.g., once every two or three frames).

In accordance with an embodiment, the method 300 provides a plurality of virtual camera shots (e.g., with each active OI being included in at least one of the plurality of virtual camera shots) which can be used for a frame displayed on the display device 109. In accordance with an embodiment, each shot of the plurality of virtual camera shots including one or more of the following associated data: a shot quality value, a total emotional quality value, and an OI target list describing specific OI which are visible within the shot.

In accordance with an embodiment, and shown in FIG. 4 is a method 400 for choosing a shot from the plurality of potential shots generated in the method 300, for display as a next frame (e.g., as a next displayed game frame). The method 400 may be performed by the director module 112. In accordance with an embodiment, at operation 402 of the method 400, the director module 112 receives output data from the cinematography module 116 (e.g., data output from operation 302 to operation 312) and optionally from the story manager module 110 (e.g., data output from operation 202 to operation 214). The output data including a list of virtual camera shots and associated data. In accordance with an embodiment, as part of operation 402 of the method 400, an optimal shot length is computed. The shot length may include a time over which there is a continuous set of displayed frames without edits or cuts between virtual cameras. The optimal shot length may be determined based on a set of predetermined rules for the application 114. The rules may include rules for shot length based on an emotional quality for the application 114 (e.g., story/game emotional arc) which may use the total emotional quality value for each shot to determine the optimal shot length over time (e.g., at each frame).

In accordance with an embodiment, at operation 404 of the method 400, each one of the plurality of virtual camera shots generated by the cinematography module 116 (e.g., during the method 300) is compared to a current displayed frame and given a transition quality rating. The transition quality rating for one of the plurality of virtual camera shots is a measure of a cost of a transition (e.g., switching) between the current displayed frame and the one virtual camera shot. In accordance with an embodiment, the cost is determined with a cost function which may include rules for determining the cost. In accordance with an embodiment, as part of operation 404 of the method 400, a plurality of transition cost functions are calculated by the director module 112 for the transition quality rating. The rules may include determining a cost based on a difference of the current displayed frame shot length to the optimal shot length (e.g., as determined in operation 402), wherein a small difference leads to a high transition quality rating. In accordance with an embodiment, the rules may include continuity rules, including: determining whether transitioning to a shot will cross a cinematography line (e.g., the director line), and determining a jump cut evaluation wherein shot sequences that are too similar are given a lower transition quality.

In accordance with an embodiment, at operation 406 of the method 400, the plurality of transition cost functions are combined (e.g., according to tunable rule weightings) to determine a single shot transition quality rating for each virtual camera shot. In accordance with an embodiment, at operation 408 of the method 400, the director module 112 chooses a shot for displaying (e.g., on the display device). The choice includes determining a total quality value for each shot from the plurality of potential shots generated in the method 300, the total quality value including the following: a transition quality value (e.g., from operation 406), an emotional quality value (e.g., from operation 310) and a shot quality value (e.g., from operation 308). The choice may include displaying a shot with the largest total quality value. In accordance with an embodiment, the chosen shot becomes the active shot (e.g., the shot displayed on the display device 109 as the next current displayed frame). Based on the new active shot being different from the previous active shot, the shot length for the active shot may be reset to zero.

The following examples are non-limiting examples of various embodiments.

Example 1. Operations are performed for determining cinematic shot quality of objects of interest within a frame of a video associated with a video game, the operations comprising: determining a plurality of objects of interest from a set of objects from within the video game; receiving game state data from the game, the game state data describing at least a set of events occurring within the game; determining a plurality of interest level values, the plurality of interest level values corresponding to a plurality of categories associated with the plurality of the objects of interest, wherein the plurality of interest level values is based on the game state data; generating a data structure for use in managing cinematography associated with the frame, the data structure facilitating the looking up of the plurality of interest level values.

Example 2. The operations of example 1, the operations further comprising one or more of: determining a plurality of starvation values for the plurality of objects of interest, wherein each of the plurality of the starvation values is inversely related to a running total of an amount of time an object of interest of the plurality of objects of interest is visible in previous frames; and wherein the data structure further facilitates the looking up of the plurality of starvation values.

Example 3. The operations of any of examples 1-2, the operations further comprising one or more of: determining a plurality of urgency values for the plurality of objects of interest, wherein each of the plurality of urgency values is based on the plurality of interest level values and the starvation value associated with an object of interest, and the urgency values represent a measure of urgency to see the object of interest in the frame; and wherein the data structure further facilitates the looking up of the plurality of urgency values.

Example 4. The operations of any of examples 1-3, the operations further comprising one or more of: determining a plurality of multidimensional state vectors, each of the plurality of multidimensional vectors describing an emotional state of an object of interest of the plurality of objects of interest; and providing the plurality of multidimensional emotional state vectors for use in determining a total emotional quality value for a shot from a virtual camera.

Example 5. The operations of any of examples 1-4, wherein based on a value for the total emotional quality for the shot being within a range, changing parameters and settings for a virtual camera to change the shot to reflect the emotional quality based on predetermined cinematography rules.

Example 6. The operations of any of examples 1-5, the operations further comprising one or more of: creating a plurality of virtual cameras, each of the plurality of virtual cameras configured to follow an object of interest from the plurality of objects of interest; for each of the plurality of virtual cameras, framing a shot for the object of interest followed by the virtual camera, the framing of the shot including looking up an urgency value in the data structure corresponding to the object of interest and determining a quality of the shot for the object of interest based on one or more of the following: the urgency value, a position of the object of interest within the shot, and a size of the object of interest within the shot.

Example 7. The operations of any of examples 1-6, wherein the operations include comparing a shot from the plurality of virtual cameras to an active shot from a previous frame and determining a measure of quality for a transition between the shot and the active shot, the measure of quality including a measure of transition for one or more of the following: emotional quality, shot quality value, and a shot length of the active shot.

Example 8. The operations of any of examples 1-7, wherein the operations include choosing a shot from the plurality of virtual cameras to become the active shot, the choosing based on at least one of: the emotional quality value for the shot, the shot quality value for the shot, and the measure of quality of transition for the shot.

Example 9. The operations of examples 1-8, wherein the operations include recomposing a camera shot to include a second object of interest in the shot based on the second object of interest entering the shot.

Example 10. A system comprising one or more computer processors, one or more computer memories, and a story manager module incorporated into the one or more computer memories, the story manager module configuring the one or more computer processors to perform the operations of any of examples 1-9.

Example 11. A computer-readable medium comprising a set of instructions, the set of instructions configuring one or more computer processors to perform any of the operations of examples 1-9.

While illustrated in the block diagrams as groups of discrete components communicating with each other via distinct data signal connections, it will be understood by those skilled in the art that the various embodiments may be provided by a combination of hardware and software components, with some components being implemented by a given function or operation of a hardware or software system, and many of the data paths illustrated being implemented by data communication within a computer application or operating system. The structure illustrated is thus provided for efficiency of teaching the present various embodiments.

It should be noted that the present disclosure can be carried out as a method, can be embodied in a system, a computer readable medium or an electrical or electro-magnetic signal. The embodiments described above and illustrated in the accompanying drawings are intended to be exemplary only. It will be evident to those skilled in the art that modifications may be made without departing from this disclosure. Such modifications are considered as possible variants and lie within the scope of the disclosure.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or with any suitable combination thereof. For example, a hardware module may include dedicated circuitry or logic that is permanently configured to perform certain operations. For example, a hardware module may be a special-purpose processor, such as a field-programmable gate array (FPGA) or an Application Specific Integrated Circuit (ASIC). A hardware module may also include programmable logic or circuitry that is temporarily configured by software to perform certain operations. For example, a hardware module may include software encompassed within a general-purpose processor or other programmable processor. Such software may at least temporarily transform the general-purpose processor into a special-purpose processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

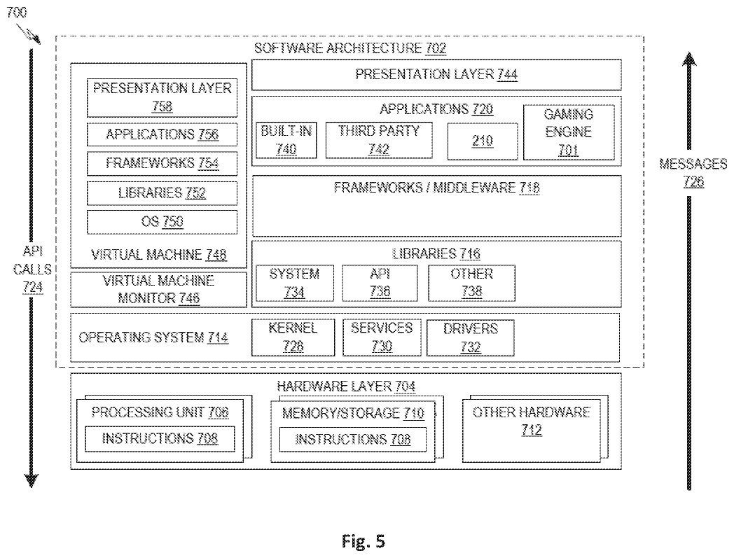

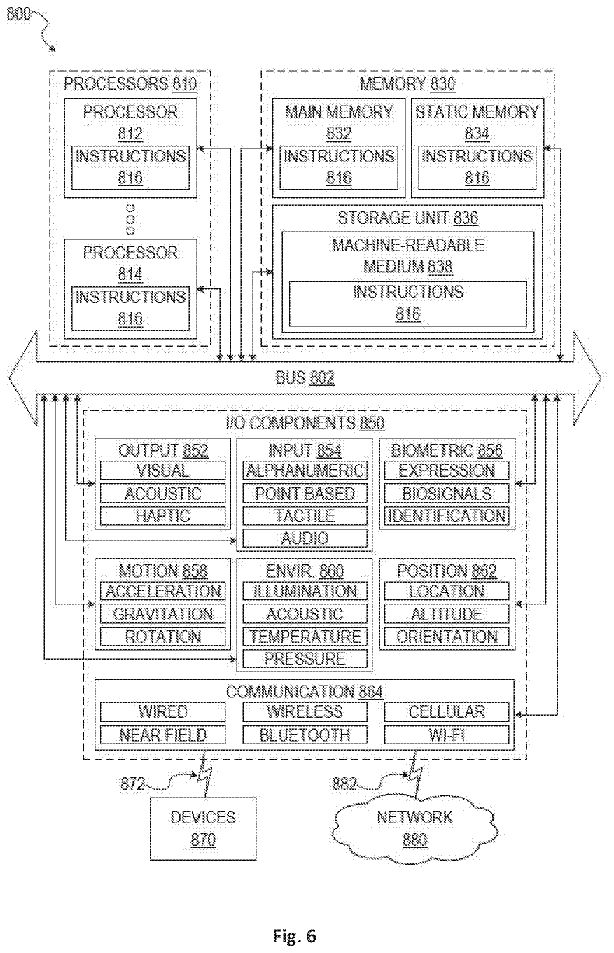

FIG. 5 is a block diagram 700 illustrating an example software architecture 702, which may be used in conjunction with various hardware architectures herein described to provide a gaming engine 701 and/or components of the story manager system. FIG. 5 is a non-limiting example of a software architecture and it will be appreciated that many other architectures may be implemented to facilitate the functionality described herein. The software architecture 702 may execute on hardware such as a machine 800 of FIG. 6 that includes, among other things, processors 810, memory 830, and input/output (I/O) components 850. A representative hardware layer 704 is illustrated and can represent, for example, the machine 800 of FIG. 6. The representative hardware layer 704 includes a processing unit 706 having associated executable instructions 708. The executable instructions 708 represent the executable instructions of the software architecture 702, including implementation of the methods, modules and so forth described herein. The hardware layer 704 also includes memory/storage 710, which also includes the executable instructions 708. The hardware layer 704 may also comprise other hardware 712.

In the example architecture of FIG. 5, the software architecture 702 may be conceptualized as a stack of layers where each layer provides particular functionality. For example, the software architecture 702 may include layers such as an operating system 714, libraries 716, frameworks or middleware 718, applications 720 and a presentation layer 744. Operationally, the applications 720 and/or other components within the layers may invoke application programming interface (API) calls 724 through the software stack and receive a response as messages 726. The layers illustrated are representative in nature and not all software architectures have all layers. For example, some mobile or special purpose operating systems may not provide the frameworks/middleware 718, while others may provide such a layer. Other software architectures may include additional or different layers.

The operating system 714 may manage hardware resources and provide common services. The operating system 714 may include, for example, a kernel 728, services 730, and drivers 732. The kernel 728 may act as an abstraction layer between the hardware and the other software layers. For example, the kernel 728 may be responsible for memory management, processor management (e.g., scheduling), component management, networking, security settings, and so on. The services 730 may provide other common services for the other software layers. The drivers 732 may be responsible for controlling or interfacing with the underlying hardware. For instance, the drivers 732 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 716 may provide a common infrastructure that may be used by the applications 720 and/or other components and/or layers. The libraries 716 typically provide functionality that allows other software modules to perform tasks in an easier fashion than to interface directly with the underlying operating system 714 functionality (e.g., kernel 728, services 730 and/or drivers 732). The libraries 816 may include system libraries 734 (e.g., C standard library) that may provide functions such as memory allocation functions, string manipulation functions, mathematic functions, and the like. In addition, the libraries 716 may include API libraries 736 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 716 may also include a wide variety of other libraries 738 to provide many other APIs to the applications 720 and other software components/modules.

The frameworks 718 (also sometimes referred to as middleware) provide a higher-level common infrastructure that may be used by the applications 720 and/or other software components/modules. For example, the frameworks/middleware 718 may provide various graphic user interface (GUI) functions, high-level resource management, high-level location services, and so forth. The frameworks/middleware 718 may provide a broad spectrum of other APIs that may be utilized by the applications 720 and/or other software components/modules, some of which may be specific to a particular operating system or platform.

The applications 720 include built-in applications 740 and/or third-party applications 742. Examples of representative built-in applications 740 may include, but are not limited to, a contacts application, a browser application, a book reader application, a location application, a media application, a messaging application, and/or a game application. Third-party applications 742 may include any an application developed using the Android™ or iOS™ software development kit (SDK) by an entity other than the vendor of the particular platform, and may be mobile software running on a mobile operating system such as iOS™, Android™, Windows® Phone, or other mobile operating systems. The third-party applications 742 may invoke the API calls 724 provided by the mobile operating system such as operating system 714 to facilitate functionality described herein.

The applications 720 may use built-in operating system functions (e.g., kernel 728, services 730 and/or drivers 732), libraries 716, or frameworks/middleware 718 to create user interfaces to interact with users of the system. Alternatively, or additionally, in some systems, interactions with a user may occur through a presentation layer, such as the presentation layer 744. In these systems, the application/module “logic” can be separated from the aspects of the application/module that interact with a user.

Some software architectures use virtual machines. In the example of FIG. 5, this is illustrated by a virtual machine 748. The virtual machine 748 creates a software environment where applications/modules can execute as if they were executing on a hardware machine (such as the machine 800 of FIG. 6, for example). The virtual machine 748 is hosted by a host operating system (e.g., operating system 714) and typically, although not always, has a virtual machine monitor 746, which manages the operation of the virtual machine 748 as well as the interface with the host operating system (i.e., operating system 714). A software architecture executes within the virtual machine 748 such as an operating system (OS) 750, libraries 752, frameworks 754, applications 756, and/or a presentation layer 758. These layers of software architecture executing within the virtual machine 748 can be the same as corresponding layers previously described or may be different.

FIG. 6 is a block diagram illustrating components of a machine 800, according to some example embodiments, configured to read instructions from a machine-readable medium (e.g., a machine-readable storage medium) and perform any one or more of the methodologies discussed herein. In some embodiments, the machine 800 is similar to the story manager device 102. Specifically, FIG. 6 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein may be executed. As such, the instructions 816 may be used to implement modules or components described herein. The instructions transform the general, non-programmed machine into a particular machine programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines that individually or jointly execute the instructions 816 to perform any one or more of the methodologies discussed herein.

The machine 800 may include processors 810, memory 830, and input/output (I/O) components 850, which may be configured to communicate with each other such as via a bus 802. In an example embodiment, the processors 810 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 812 and a processor 814 that may execute the instructions 816. The term “processor” is intended to include multi-core processor that may comprise two or more independent processors (sometimes referred to as “cores”) that may execute instructions contemporaneously. Although FIG. 6 shows multiple processors, the machine 800 may include a single processor with a single core, a single processor with multiple cores (e.g., a multi-core processor), multiple processors with a single core, multiple processors with multiples cores, or any combination thereof.

The memory/storage 830 may include a memory, such as a main memory 832, a static memory 834, or other memory, and a storage unit 836, both accessible to the processors 810 such as via the bus 802. The storage unit 836 and memory 832, 834 store the instructions 816 embodying any one or more of the methodologies or functions described herein. The instructions 816 may also reside, completely or partially, within the memory 832, 834, within the storage unit 836, within at least one of the processors 810 (e.g., within the processor's cache memory), or any suitable combination thereof, during execution thereof by the machine 800. Accordingly, the memory 832, 834, the storage unit 836, and the memory of processors 810 are examples of machine-readable media 838.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store the instructions 816. The term “machine-readable medium” shall also be taken to include any medium, or combination of multiple media, that is capable of storing instructions (e.g., instructions 816) for execution by a machine (e.g., machine 800), such that the instructions, when executed by one or more processors of the machine 800 (e.g., processors 810), cause the machine 800 to perform any one or more of the methodologies or operations, including non-routine or unconventional methodologies or operations, or non-routine or unconventional combinations of methodologies or operations, described herein. Accordingly, a “machine-readable medium” refers to a single storage apparatus or device, as well as “cloud-based” storage systems or storage networks that include multiple storage apparatus or devices. The term “machine-readable medium” excludes signals per se.

The input/output (I/O) components 850 may include a wide variety of components to receive input, provide output, produce output, transmit information, exchange information, capture measurements, and so on. The specific input/output (I/O) components 850 that are included in a particular machine will depend on the type of machine. For example, portable machines such as mobile phones will likely include a touch input device or other such input mechanisms, while a headless server machine will likely not include such a touch input device. It will be appreciated that the input/output (I/O) components 850 may include many other components that are not shown in FIG. 6. The input/output (I/O) components 850 are grouped according to functionality merely for simplifying the following discussion and the grouping is in no way limiting. In various example embodiments, the input/output (I/O) components 850 may include output components 852 and input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the input/output (I/O) components 850 may include biometric components 856, motion components 858, environmental components 860, or position components 862, among a wide array of other components. For example, the biometric components 856 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 862 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The input/output (I/O) components 850 may include communication components 864 operable to couple the machine 800 to a network 880 or devices 870 via a coupling 882 and a coupling 872 respectively. For example, the communication components 864 may include a network interface component or other suitable device to interface with the network 880. In further examples, the communication components 864 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 870 may be another machine or any of a wide variety of peripheral devices (e.g., a peripheral device coupled via a Universal Serial Bus (USB)).

Moreover, the communication components 864 may detect identifiers or include components operable to detect identifiers. For example, the communication components 864 may include Radio Frequency Identification (RFID) tag reader components, NFC smart tag detection components, optical reader components (e.g., an optical sensor to detect one-dimensional bar codes such as Universal Product Code (UPC) bar code, multidimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 862, such as, location via Internet Protocol (IP) geo-location, location via Wi-Fi® signal triangulation, location via detecting a NFC beacon signal that may indicate a particular location, and so forth.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within the scope of embodiments of the present disclosure as represented by the appended claims. The specification and drawings are, accordingly, to be regarded in an illustrative rather than a restrictive sense.

1. A system comprising:
one or more computer processors;
one or more computer memories;
a story manager module incorporated into the one or more computer memories, the story manager module configured to perform operations for determining cinematic shot quality of objects of interest within a frame of a video associated with a video game, the operations comprising:
determining a plurality of objects of interest from a set of objects from within the video game;
receiving game state data from the game, the game state data describing at least a set of events occurring within the game;
determining a plurality of interest level values, the plurality of interest level values corresponding to a plurality of categories associated with the plurality of the objects of interest, wherein the plurality of interest level values is based on the game state data;
generating a data structure for use in managing cinematography associated with the frame, the data structure facilitating the looking up of the plurality of interest level values.

2. The system of claim 1, the operations further comprising:
determining a plurality of starvation values for the plurality of objects of interest, wherein each of the plurality of the starvation values is inversely related to a running total of an amount of time an object of interest of the plurality of objects of interest is visible in previous frames; and
wherein the data structure further facilitates the looking up of the plurality of starvation values.

3. The system of claim 2, the operations further comprising:
determining a plurality of urgency values for the plurality of objects of interest, wherein each of the plurality of urgency values is based on the plurality of interest level values and the starvation value associated with an object of interest, and the urgency values represent a measure of urgency to see the object of interest in the frame; and
wherein the data structure further facilitates the looking up of the plurality of urgency values.

4. The system of claim 1, the operations further comprising:
determining a plurality of multidimensional state vectors, each of the plurality of multidimensional vectors describing an emotional state of an object of interest of the plurality of objects of interest; and
providing the plurality of multidimensional emotional state vectors for use in determining a total emotional quality value for a shot from a virtual camera.

5. The system of claim 4, wherein based on a value for the total emotional quality for the shot being within a range, changing parameters and settings for a virtual camera to change the shot to reflect the emotional quality based on predetermined cinematography rules.

6. The system of claim 3, the operations further comprising:
creating a plurality of virtual cameras, each of the plurality of virtual cameras configured to follow an object of interest from the plurality of objects of interest;
for each of the plurality of virtual cameras, framing a shot for the object of interest followed by the virtual camera, the framing of the shot including looking up an urgency value in the data structure corresponding to the object of interest and determining a quality of the shot for the object of interest based on one or more of the following: the urgency value, a position of the object of interest within the shot, and a size of the object of interest within the shot.

7. The system of claim 6, wherein the operations include comparing a shot from the plurality of virtual cameras to an active shot from a previous frame and determining a measure of quality for a transition between the shot and the active shot, the measure of quality including a measure of transition for one or more of the following: emotional quality, shot quality value, and a shot length of the active shot.

8. The system of claim 7, wherein the operations include choosing a shot from the plurality of virtual cameras to become the active shot, the choosing based on at least one of: the emotional quality value for the shot, the shot quality value for the shot, and the measure of quality of transition for the shot.

9. The system of claim 6, wherein the operations include recomposing a camera shot to include a second object of interest in the shot based on the second object of interest entering the shot.

10. A non-transitory computer-readable medium comprising a set of instructions that, when executing by one or more computer processors, cause the one or more computer processors to perform operations for determining cinematic shot quality of objects of interest within a frame of a video associated with a video game, the operations comprising:
determining a plurality of objects of interest from a set of objects from within the video game;
receiving game state data from the game, the game state data describing at least a set of events occurring within the game;
determining a plurality of interest level values, the plurality of interest level values corresponding to a plurality of categories associated with the plurality of the objects of interest, wherein the plurality of interest level values is based on the game state data;
generating a data structure for use in managing cinematography associated with the frame, the data structure facilitating the looking up of the plurality of interest level values.

11. The non-transitory computer-readable medium of claim 10, the operations further comprising:
determining a plurality of starvation values for the plurality of objects of interest, wherein each of the plurality of the starvation values is inversely related to a running total of an amount of time an object of interest of the plurality of objects of interest is visible in previous frames; and
wherein the data structure further facilitates the looking up of the plurality of starvation values.

12. The non-transitory computer-readable medium of claim 11, the operations further comprising:
determining a plurality of urgency values for the plurality of objects of interest, wherein each of the plurality of urgency values is based on the plurality of interest level values and the starvation value associated with an object of interest, and the urgency values represent a measure of urgency to see the object of interest in the frame; and
wherein the data structure further facilitates the looking up of the plurality of urgency values.

13. The non-transitory computer-readable medium of claim 10, the operations further comprising:
determining a plurality of multidimensional state vectors, each of the plurality of multidimensional vectors describing an emotional state of an object of interest of the plurality of objects of interest; and
providing the plurality of multidimensional emotional state vectors for use in determining a total emotional quality value for a shot from a virtual camera.

14. The non-transitory computer-readable medium of claim 13, wherein based on a value for the total emotional quality for the shot being within a range, changing parameters and settings for a virtual camera to change the shot to reflect the emotional quality based on predetermined cinematography rules.

15. The non-transitory computer-readable medium of claim 12, the operations further comprising:
creating a plurality of virtual cameras, each of the plurality of virtual cameras configured to follow an object of interest from the plurality of objects of interest;
for each of the plurality of virtual cameras, framing a shot for the object of interest followed by the virtual camera, the framing of the shot including looking up an urgency value in the data structure corresponding to the object of interest and determining a quality of the shot for the object of interest based on one or more of the following: the urgency value, a position of the object of interest within the shot, and a size of the object of interest within the shot.

16. The non-transitory computer-readable medium of claim 15, wherein the operations include comparing a shot from the plurality of virtual cameras to an active shot from a previous frame and determining a measure of quality for a transition between the shot and the active shot, the measure of quality including a measure of transition for one or more of the following: emotional quality, shot quality value, and a shot length of the active shot.

17. The non-transitory computer-readable medium of claim 16, wherein the operations include choosing a shot from the plurality of virtual cameras to become the active shot, the choosing based on at least one of: the emotional quality value for the shot, the shot quality value for the shot, and the measure of quality of transition for the shot.

18. A method comprising:
performing, using one or more computer processors, operations for determining cinematic shot quality of objects of interest within a frame of a video associated with a video game, the operations comprising:
determining a plurality of objects of interest from a set of objects from within the video game;
receiving game state data from the game, the game state data describing at least a set of events occurring within the game;
determining a plurality of interest level values, the plurality of interest level values corresponding to a plurality of categories associated with the plurality of the objects of interest, wherein the plurality of interest level values is based on the game state data;
determining a plurality of starvation values for the plurality of objects of interest, wherein each of the plurality of the starvation values is inversely related to a running total of an amount of time an object of interest of the plurality of objects of interest is visible in previous frames;
determining a plurality of urgency values for the plurality of objects of interest, wherein each of the plurality of urgency values is based on the plurality of interest level values and the starvation value associated with an object of interest, and the urgency values represent a measure of urgency to see the object of interest in the frame;
generating a data structure for use in managing cinematography associated with the frame, the data structure facilitating the looking up of the plurality of interest level values and urgency values.

19. The method of claim 18, the operations further comprising:
determining a plurality of multidimensional state vectors, each of the plurality of multidimensional vectors describing an emotional state of an object of interest of the plurality of objects of interest;
providing the plurality of multidimensional emotional state vectors for use in determining a total emotional quality value for a shot from a virtual camera; and
based on a value for the total emotional quality for the shot being within a range, changing parameters and settings for a virtual camera to change the shot to reflect the emotional quality based on predetermined cinematography rules.

20. The method of claim 18, the operations further comprising:
creating a plurality of virtual cameras, each of the plurality of virtual cameras configured to follow an object of interest from the plurality of objects of interest;
for each of the plurality of virtual cameras, framing a shot for the object of interest followed by the virtual camera, the framing of the shot including looking up an urgency value in the data structure corresponding to the object of interest and determining a quality of the shot for the object of interest based on one or more of the following: the urgency value, a position of the object of interest within the shot, and a size of the object of interest within the shot;
comparing a shot from the plurality of virtual cameras to an active shot from a previous frame and determining a measure of quality for a transition between the shot and the active shot, the measure of quality including a measure of transition for one or more of the following: emotional quality, shot quality value, and a shot length of the active shot; and
choosing a shot from the plurality of virtual cameras to become the active shot, the choosing based on at least one of: the emotional quality value for the shot, the shot quality value for the shot, and the measure of quality of transition for the shot.
